(19) United States
(12) Patent Application Publication
(10) Pub. No.: US 2025/0392934 A1
(43) Pub. Date: Dec. 25, 2025

(54) CUSTOMIZED FRONT-HAUL FOR CELLULAR NON-TERRESTRIAL NETWORK SYSTEMS

(71) Applicant: DISH Wireless L.L.C., Littleton, CO (US)

(72) Inventors: Mehdi Alasti, Arlington, VA (US); Lin-Nan Lee, Potomac, MD (US); Khalid Al-Mufti, Sterling, VA (US); David Zufall, Littleton, CO (US); Sourabh Gupta, Ashburn, VA (US)

(21) Appl. No.: 18/929,231

(22) Filed: Oct. 28, 2024

Related U.S. Application Data
(60) Provisional application No. 63/662,879, filed on Jun. 21, 2024.

(51) Int. Cl. H04W 24/08; H04B 7/185

(52) U.S. Cl. CPC H04W 24/08; H04B 7/18517; H04B 7/1855

(57) ABSTRACT

A non-terrestrial cellular network system and associated methods are provided. A satellite, comprising a radio unit (RU), can function as part of a cellular network. The system can include a gateway system, comprising a distributed unit (DU) and a configuration manager. The configuration manager can be configured to determine and analyze a characteristic of the non-terrestrial cellular network system. One or more updated parameters can be transmitted to the RU of the satellite in response to analyzing the characteristic. The RU of the satellite is configured to update functionality based on the one or more updated parameters.

### CROSS-REFERENCE TO RELATED APPLICATIONS

This application claims priority to U.S. Provisional Patent Application No. 63/662,879, filed Jun. 21, 2024, entitled “Customized Front-Haul for Cellular Non-Terrestrial Network Systems,” the entire disclosure of which is hereby incorporated by reference for all purposes.

### BACKGROUND

On a cellular terrestrial network (TN), a base station (BS) is located in a fixed position and provides cellular network access to a roughly fixed geographic region. While the amount of network traffic caused by user equipment (UE) can vary, the conditions under which the BS operates is relatively static. For a cellular non-terrestrial network (NTN), a satellite in low earth orbit (LEO) or middle earth orbit (MEO) orbits the earth and provides cellular network coverage to a continuously changing geographic region. As such, the conditions under which the satellite operates as a BS as part of the cellular network change frequently. Arrangements detailed herein help optimize operation.

### SUMMARY

In some embodiments, a non-terrestrial cellular network system is presented. The system can include a satellite, comprising a radio unit (RU), the satellite functioning as part of a cellular network. The system can include a gateway system, comprising a distributed unit (DU) and a configuration manager. The configuration manager can be configured to determine a characteristic of the non-terrestrial cellular network system. The configuration manager can be configured to analyze the characteristic of the non-terrestrial cellular network system. The configuration manager can be configured to transmit one or more updated parameters to the RU of the satellite in response to analyzing the characteristic. The RU of the satellite can be configured to update functionality based on the one or more updated parameters. The RU of the satellite can be configured to communicate with a plurality of user equipment (UEs) in accordance with the updated one or more parameters.

Embodiments of such a system may include one or more of the following features: The updated parameters can include an adjustment to an advanced sleep mode (ASM) setting of the RU that causes one or more components of the RU to be powered down. The configuration manager may be configured to, after transmitting the one or more updated parameters to the RU of the satellite in response to analyzing the characteristic, transmit an additional updated parameter to the RU comprising a wake-up command that adjusts the ASM setting and causes the one or more components of the RU at the satellite to be powered up. The updated parameters can include an adjustment to a beamforming pattern of the RU. The updated parameters can include an adjustment to a subcarrier spacing (SCS) at the RU. The updated parameters can include an adjustment to a channel bandwidth at the RU. The characteristic of the non-terrestrial cellular network system can include a location of the satellite in orbit. The characteristic of the non-terrestrial cellular network system can include an amount of UE traffic on the cellular network. The characteristic of the non-terrestrial cellular network system can include a beam-forming pattern of an antenna array of the satellite. The RU of the satellite can include a software-defined radio (SDR).

In some embodiments, a method for using a non-terrestrial cellular network system is presented. The method can include communicating, by a distributed unit located at a satellite gateway system, via a satellite, with a plurality of user equipment (UEs) via a cellular communication protocol. The method can include determining, by a configuration manager of the satellite gateway system, a characteristic of the satellite. The method can include analyzing, by the configuration manager of the satellite gateway system, the characteristic of the non-terrestrial cellular network system. The method can include transmitting, by the satellite gateway system, one or more updated parameters to the RU of the satellite in response to analyzing the characteristic. The RU of the satellite can be configured to update functionality based on the one or more updated parameters. The method can include communicating, by the distributed unit located at the satellite gateway system, via the satellite and the RU using the one or more updated parameters, with the plurality of UEs via the cellular communication protocol.

Embodiment of such a method can include on e or more of the following features: The updated parameters can include an adjustment to an advanced sleep mode (ASM) setting of the RU that causes one or more components of the RU to be powered down. The method can include, after transmitting the one or more updated parameters to the RU of the satellite in response to analyzing the characteristic, transmitting, by the satellite gateway system, an additional updated parameter to the RU comprising a wake-up command that adjusts the ASM setting and causes the one or more components of the RU at the satellite to be powered up. The updated parameters can include an adjustment to a beamforming pattern of the RU. The updated parameters can include an adjustment to a subcarrier spacing (SCS) at the RU. The updated parameters can include an adjustment to a channel bandwidth at the RU. The characteristic of the non-terrestrial cellular network system can include a location of the satellite in orbit. The characteristic of the non-terrestrial cellular network system can include an amount of UE traffic on a terrestrial cellular network. The characteristic of the non-terrestrial cellular network system can include a beam-forming pattern of an antenna array of the satellite. The method can include receiving, by the satellite, the one or more updated parameters. The method can include updating, by a software-defined radio (SDR) of the RU of the satellite a configuration based on the received one or more updated parameters.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an embodiment of a satellite orbiting over geographic regions of varying UE density.

FIG. 2 illustrates an embodiment of a non-terrestrial network system.

FIG. 3 illustrates an embodiment of a cellular network core.

FIG. 4 illustrates an embodiment of a cloud-implemented cellular network core.

FIG. 5 illustrate an embodiment of a method for using a non-terrestrial network system.

### DETAILED DESCRIPTION

Satellites can be incorporated as part of a ground-based cellular network or work in conjunction with a ground-based cellular network. Alternatively, a cellular network can include no ground-based base stations (BSs) and rely on only satellites for communication with UEs. Therefore, a cellular network can include TN components, NTN components, or both.

Ground-based BSs can provide cellular network coverage to relatively fixed geographic regions. In contrast, a satellite can be used to provide cellular network coverage over a constantly-changing geographic region due to the orbit of the satellite (assuming the satellite is in LEO or MEO). A satellite functioning as part of a cellular NTN can encounter rapidly changing cellular network conditions. For example, a satellite that passes over a busy metropolitan area may provide service to thousands of UEs. A short time thereafter, the satellite may have a coverage area that is over the ocean or sparsely populated country and may provide coverage to relatively few UEs.

Rather than relying on fixed parameters for operating an RU that resides on the satellite, embodiments detailed herein allow for parameters of the RU to be frequently updated, such as in response to the characteristics of the geographic region that the satellite is passing over, the satellite's orbit, and the cellular network load. Further detail regarding such embodiments is provided in relation to the figures.

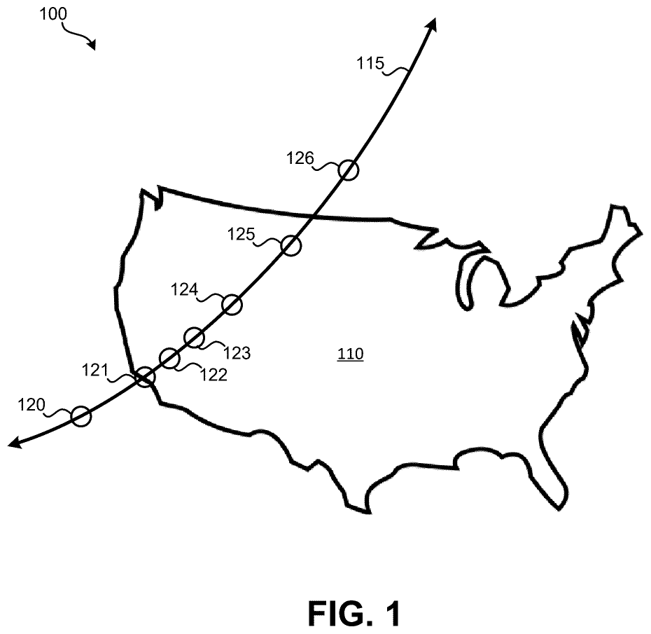

FIG. 1 illustrates an embodiment 100 of a satellite orbiting over geographic regions of varying UE density. In embodiment 100, a satellite is in LEO or MEO along orbital path 115. Orbital path 115 results in the satellite being alternatively over areas of high density, medium, density, and low density of UEs. For example, the satellite may orbit along orbital path 115 from the southwest to the northeast. In geographic area 120, few UEs may be provided service, such as a relatively small number of UEs located on boats, from a satellite orbiting above having a line-of-sight path to the UEs. In geographic area 121, a relatively high number of UEs can be provided service over the greater Los Angeles metropolitan area when the satellite is overhead with a line-of-sight path to the UEs. For geographic area 122, fewer UEs may be provided service than in geographic area 121, but more than in geographic area 120. (Alternatively, more UEs may be serviced in geographic area 122 than in geographic area 121 due to the relatively fewer number of ground-based base stations.) Again in geographic area 123, a large number of UEs may be serviced in the greater Las Vegas metropolitan area. Geographic areas 124 and 125 can have relatively few UEs needing service when the satellite is orbiting overhead. Alternatively, it is also possible that in geographic areas 124 and 125, a significant amount of communication traffic with UEs may be present due to the sparsity of a cellular TN. When the satellite is providing service to geographic area 126, different rules may be applied to how the satellite an on-board RU function since the satellite is operating above a different country, in this case, Canada. (In some situations, cellular service may be prohibited from being provided by the satellite in various countries.)

Orbital path 115 is merely exemplary to illustrate how the number of UEs and amount of communication traffic between UEs and a satellite can vary significantly based on where the satellite is located in orbit.

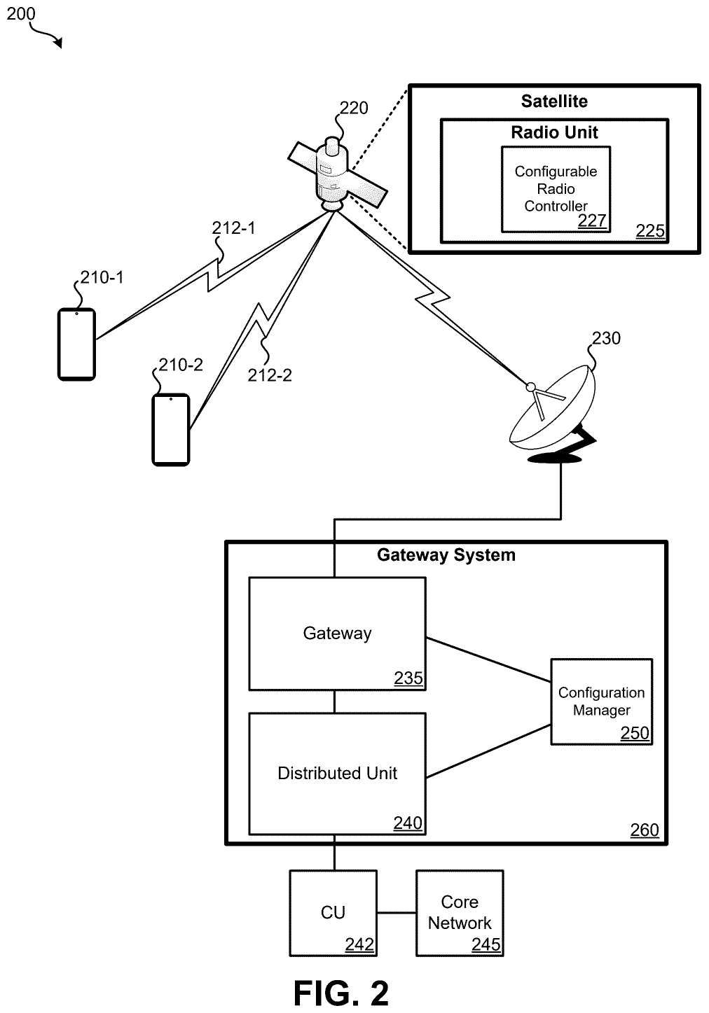

FIG. 2 illustrates an embodiment of a non-terrestrial network system 200 (“system 200”). System 200 can include: UEs 210 (e.g., UE 210-1, UE 210-2), satellite 220, RU 225, configurable radio controller 227, satellite antenna 230, gateway 235, configurable radio controller 237, distributed unit 240, centralized unit (CU) 242, cellular core network 245, and configuration manager 250. UEs 210 represent two instances of UEs, which can be smartphones, IoT devices, sensors, computers, access points (APs), cellular modems, or any other device that can communicate via a cellular communication protocol with satellite 220. Individual UEs of UEs 210 may or may not be able to communicate with a cellular TN.

In a real-world embodiment, many satellites that form a constellation of satellites may be in LEO or MEO orbit. At any given time, one or more of these satellites can have a roughly line-of-sight path to UEs in a geographic region such that cellular network coverage of the satellite is continuous. Therefore, while the particular satellite that provides coverage may frequently change, cellular network coverage remains present for the geographic region. For simplicity, FIG. 2 illustrates a single satellite 220; however, it should be understood that satellite 220 can be part of a constellation of satellites to cooperatively provide a region with continuous cellular network access.

Satellite 220 communicates directly with UEs 210 and also with satellite antenna 230, thus allowing data to be routed between UEs 210 and gateway 235. Satellite 220 can operate as part of a cellular network, such as a 5G New Radio (NR) cellular network. Additional cellular network protocols are also possible, such as future 6G protocols and beyond. The cellular network of which satellite 220 functions may be a mixed TN and NTN which, therefore, may use both ground-based base stations and satellite. Alternatively, a cellular network can be present that is wholly an NTN and only uses satellites for communication with UE.

In a 5G cellular network, a gNodeB (gNB) includes various logical components, including a radio unit (RU), a distributed unit (DU), and a central unit (CU). The RU serves to bridge between the wireless RF communicates and the digital domain. The DU can perform radio processing and control functions, such as wireless communication scheduling with multiple UEs. The CU supports higher layers of the protocol stack, such as the service data adaption protocol (SDAP), radio resource control (RRC), and packet data convergence protocol (PDCP) protocol layers. In system 200, satellite 220 includes an on-board RU 225 (while DU 240 resides at ground-based gateway system 260). RU 225 includes configurable radio controller 227.

Configurable radio controller 227 can include a software-defined radio (SDR). In an SDR, various components are implemented using software, thus allowing for greater flexibility in how such components function. At least some of the signal processing performed on-board satellite 220 is performed using configurable radio controller 227. An SDR can provide energy management capability. That is, SDRs can optimize satellite power usage derived from solar panels and batteries. Efficient energy management directly impacts the size, weight, cost of the satellite, and the cost to launch it. SDRs can optimize support for different channel bandwidths. SDRs can support various channel BWs, such as the 3 MHz channel BW specified in 3GPP Release 18 for NR NTN. SDRs can provide support for different frequency bands and bandwidths. SDRs can operate across different frequency bands and bandwidths, catering to various service areas and requirements. SDRs can help provide energy efficiency over oceans. SDRs can reduce energy consumption for LEO satellites over oceanic regions while maintaining essential communications and satellite functionality. SDRs can provide beamforming and interference management. SDRs can enable advanced beamforming techniques and effective interference management with terrestrial networks in each geographical area.

Satellite antenna 230 allows for communication between gateway 235 and satellite 220. Gateway 235, DU 240, and configuration manager 250 can function as part of gateway system 260. Distributed unit 240 can perform various cellular functions for RU 225. A primary function that DU 240 provides is scheduling services for data transmissions between UEs 210 and RU 225. Therefore, scheduling of communications between RU 225 and UEs 210 is performed at gateway system 260 by DU 240. Gateway 235 may have a configurable radio incorporated as part of it to enable modification and customization of the wireless communication link between satellite antenna 230 and satellite 220.

In an open radio access network (O-RAN) architecture, the front-haul interface includes four planes: a user plane (U-plane) that is responsible for the transport of user data; a control plane (C-plane) that manages the transport of control commands and PHY-layer control message; a synchronization plane (S-plane) that handles timing management among DUs and RUs, and a management plane (M-plane) that facilitates the configuration and management of RU functionalities.

Configuration manager 250 can access various data in order to modify and customize how radio unit 225 functions. Configuration manager 250 has access to geographic and orbit data of satellite 220 that can be used to determine where the satellite is located and the geographic region that is currently and will be provided with cellular coverage by satellite 220. This data can indicate the expected cellular traffic load for the geographic region at the given day/time that satellite 220 will be providing service. As an example, in a region where TN coverage is poor, more UEs may attempt to connect with and communicate with the cellular network via RU 225. The data accessible by configuration manager 250 can be used to determine the expected traffic load based on time of day, day of week, and other factors, such as historical traffic measurements for the geographic region and expected number of UEs in the geographic region (e.g., that have recently communicated with a TN of the cellular network). The data may further indicate sub-geographic regions at which satellite 220 is to target beams to provide coverage for UEs. Preconfigured beamforming configurations can be created and stored by configuration manager 250. Utilizing the M-Plane and C-Plane of the O-RAN front haul, configuration data can be sent to RU 225 for reconfiguration.

More specifically, using the M-Plane, configuration manager 250 can support Advanced Sleep Mode (ASM) to put RU 225 into a sleep mode for energy efficiency. Based on geographical area, time, and network conditions, an appropriate ASM configuration can be determined by configuration management 250 and communicate this configuration to the RU, such as via the M-plane. ASM reduces power consumption of RU 225 by powering down (or putting into a low power mode) some RU components, such as processors and power amplifiers, to allow saving energy for a defined period of time. As an example, when RU 225 is communicating with few UEs, RU 225 may be partially powered down. ASM can be used when the satellite is over a region of low UE density, such as the ocean. ASM may also be used when RU 225 is located over a geographic region where communication with UEs is prohibited, such as a country where cellular access via the satellite is not permitted.

After a time, configuration manager 250 can cause a wake-up command to be transmitted to the RU to power up one or more of the RU components that have been powered down or set to a low power mode.

Configuration manager 250, via M-Plane with RU 225, can support the configuration of frequency bands and channel bandwidths (BWs). Depending on geographical area, time, network conditions (e.g., UE traffic volume), and/or regulations, a SDR of configurable radio controller 227 of RU 225 can be assigned by configuration manager 250 to use a particular frequency band, channel BW, and subcarrier spacing (SCS) and communicates the configuration with RU through M-Plane. Configuration manager 250 may also reconfigure the carrier frequency used by RU 225 to communicate with UEs 210.

Configuration manager 250, via M-Plane and C-Plane communication with RU 225, can support NTN-specific beamforming options, while adding the supporting enhancements to the C, U, S, and M-plane, thus enhancing NTN-TN interference management and communication efficiency. Satellite 220 can maintain an array of beamforming coefficients to define various beams to be used in various geographic locations in accordance with the O-RAN predefined beamforming feature. Additionally, a location of satellite 220 and timing information can be used by configuration manager 250 to determine and send precise beamforming instructions via the O-RAN M-Plane to the DU, which sends to the RU. Such an arrangement can allow satellite 220 to optimize beamforming dynamically based on its position and coverage needs.

The rapid movement of RU 225 aboard a LEO or MEO satellite, traveling at about 16,000 miles per hour for LEO, causes significant variations in fronthaul link latency with gateway system 260. This speed, combined with extended distances, poses challenges for operation, especially in timing synchronization. Maintaining close clock synchronization among RUs, DUs, and a master clock is crucial in the O-RAN fronthaul S-Plane for cellular communications.

The Precision Time Protocol (PTP), as defined in the IEEE 1588 standard, achieves synchronization by managing clock offset and link latency. However, the dynamic latency of the fronthaul link due to satellite movement may render PTP insufficient to maintain close enough synchronization and may require a modified arrangement to account for the dynamic latency fluctuations caused by the orbiting satellite. In addition to the varying amount of latency, effective transmit and receive buffer window management on the O-RAN M-Plane at RUs and DUs may be needed to account for these satellite link latency variations.

Conventionally, PTP synchronizes RU and DU clocks via precise message timestamping, assuming constant and equal latencies. When RU 225 is located onboard satellite 220, such as in LEO, varying satellite distances can exceed O-RAN fronthaul limits, thereby rendering PTP unable to provide accurate synchronization. The PTP can be modified as detailed herein for unique clock synchronization in an NTN in which a cellular network component is located at the satellite, such as an RU and/or DU (referred to as a regenerative NTN). In this architecture, a timing grandmaster clock (T-GM) can be located at gateway system 260, with RU 225 located on satellite 220. DU 240, located at gateway system 260, can use a Time-Subordinated clock (T-TSC). Similarly, RU 225 can use a T-TSC. RU 225 and DU 240 synchronize their T-TSCs with the T-GM at gateway system 260 using the proposed modification to PTP.

In the proposed modification, satellite ephemeris data is used to modify the clock synchronization process. Based on the expected location of where the satellite will be located, the distance between the satellite and the gateway can be predicted with a high degree of accuracy. In addition to exchanging timestamp information, the position of the satellite can be used to further refine the timing synchronization of the clocks. For example, if the satellite is moving away from gateway system 260, an additional delay value can be added; if the satellite is moving toward gateway system 260, the additional delay can be subtracted. In some embodiments, an artificial intelligence or, more specifically, a machine learning arrangement can be used to determine the specific delay values that should be added or subtracted based on satellite location.

Additionally or alternatively, the transmit and receive buffer windows can be adjusted at RU 225 and DU 240. Split Option 7.2x includes managing transmit and receive buffer windows for transmitting C-Plane and U-Plane messages over the O-RAN fronthaul, according to the transmit and receive timing of the radio interface based on the O-RAN fronthaul framework. The transmit and receive buffer window management is affected by both the processing and fronthaul delays, which include link latency and small jitters from switches and routers. The RU receive window size accommodates these fluctuations in fronthaul delay and the DU transmit window size. While current O-RAN fronthaul transmit and receive buffer management is optimized for fixed link latency, the time-varying latency of regenerative NTN poses a significant challenge. For example, as the latency increases (e.g., satellite 220 becoming farther from gateway system 260), increasing the transmit and receive buffer windows may be necessary to ensure proper functionality.

To address this, in some embodiments an elastic buffer that dynamically adjusts transmit and receive buffer windows based on satellite ephemeris data (e.g., satellite location) can be used. Such an arrangement accounts for the time variations in link latency, ensuring the buffer to accommodate the fluctuating latencies and maintain reliable communication, and preventing transmission failures. Such embodiments can enhance the robustness and efficiency of O-RAN fronthaul operations, making it more efficient for regenerative NTN scenarios. Embodiments can use an enhanced transmit and receive buffer window management on the M-Plane to effectively manage the time-varying nature of LEO satellite link.

In some embodiments, configuration manager 250 can include a trained machine learning model that is used to determine how the RU is to be configured based on inputs that include one or more of: orbital location; time of day; day of week; known number of UEs in the geographic region. For example, a training data set can be created based on communications with the satellite (and/or other satellites of the constellation) for a period of time. For this data, a preferred RU configuration may be mapped to data within the training data set. Once a sufficient training data set has been created, a trained machine learning model can be created, which can be a neural network or any other machine learning model. The machine learning model can then use some or all of the various possible inputs to determine how the RU should be configured for various locations along its orbital path. These configurations can include, whether ASM and what mode of ASM should be enabled, where spot beams should be defined, and other various customizations.

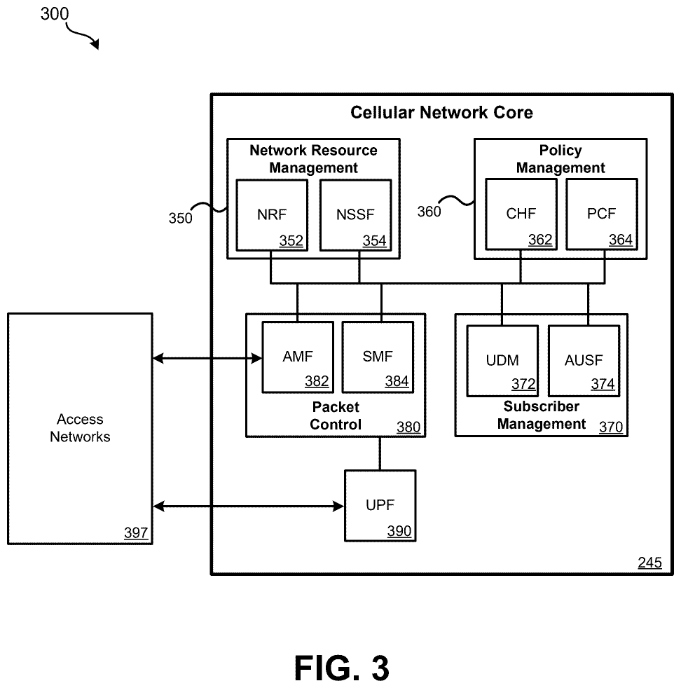

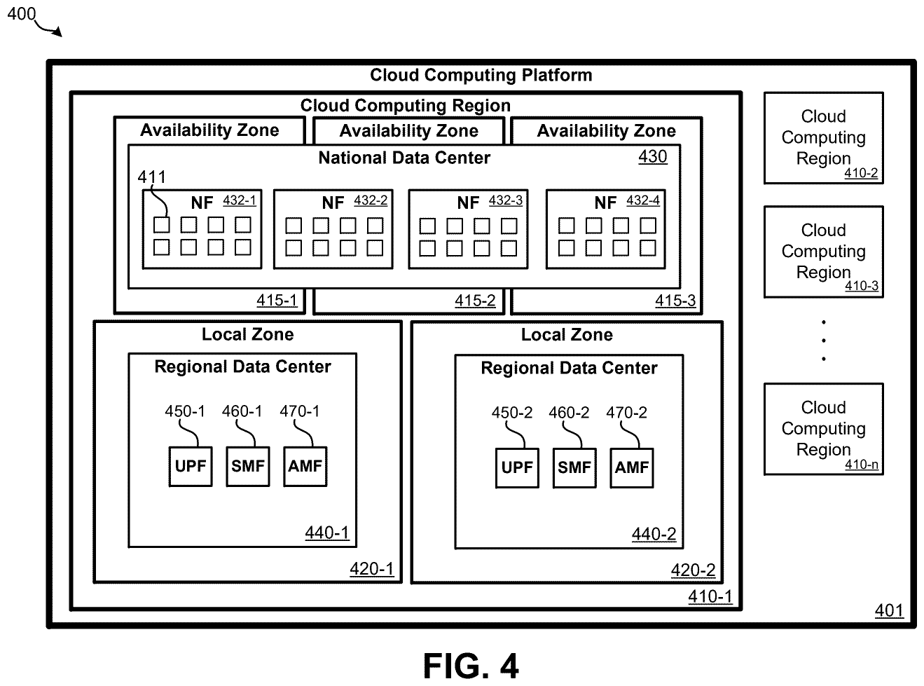

DU 240 of gateway system 260 is in communication with central unit 242. CU 242 can be located on site at gateway system 260 or can be located remotely from gateway system 260. Cellular core network 245 can include a CU or the CU may be located locally at gateway system 260. Further details of cellular core network 245 is provided in relation to FIGS. 3 and 4.

FIG. 4 illustrates cellular network core 245, according to certain embodiments. Cellular network core 245 can be physically distributed across data centers or located at a national data center (NDC), such as detailed in relation to FIG. 4, can perform various core functions of the cellular network. Cellular network core 245 can include: network resource management components 350; policy management components 360; subscriber management components 370; and packet control components 380. Individual components may communicate via a bus, thus allowing various components of core 339 to communicate with each other directly. Core 339 is simplified to show some key components. Implementations can involve additional components.

Network resource management components 350 can include: Network Repository Function (NRF) 352 and Network Slice Selection Function (NSSF) 354. NRF 352 can allow 5G network functions (NFs) to register and discover each other via a standards-based application programming interface (API). NSSF 354 can be used by AMF 382 to assist with the selection of a network slice that will serve a particular UE (e.g., UEs 210 of FIG. 2).

Policy management components 360 can include: Charging Function (CHF) 362 and Policy Control Function (PCF) 364. CHF 362 allows charging services to be offered to authorized network functions. Converged online and offline charging can be supported. PCF 364 allows for policy control functions and the related 5G signaling interfaces to be supported.

Subscriber management components 370 can include: Unified Data Management (UDM) 372 and Authentication Server Function (AUSF) 374. UDM 372 can allow for generation of authentication vectors, user identification handling, NF registration management, and retrieval of UE individual subscription data for slice selection. AUSF 374 performs authentication with UEs.

Packet control components 380 can include: Access and Mobility Management Function (AMF) 382 and Session Management Function (SMF) 384. AMF 382 can receive connection- and session-related information from UEs and is responsible for handling connection and mobility management tasks. SMF 384 is responsible for interacting with the decoupled data plane, creating updating and removing Protocol Data Unit (PDU) sessions, and managing session context with the User Plane Function (UPF).

User plane function (UPF) 390 can be responsible for packet routing and forwarding, packet inspection, quality of service (QOS) handling, and external PDU sessions for interconnecting with a Data Network (DN) (e.g., the Internet) or various access networks 397. Access networks 397 can include TN cellular base stations functioning as part of a RAN of satellite 220 of FIG. 2.

While FIG. 3 illustrates various components of cellular network 320, it should be understood that other embodiments of cellular network 320 can vary the arrangement, communication paths, and specific components of cellular network 320. While RU 325 may include specialized radio access componentry to enable wireless communication with UE 310, other components of cellular network 320 may be implemented using either specialized hardware, specialized firmware, and/or specialized software executed on a general-purpose server system. In a virtualized arrangement, specialized software on general-purpose hardware may be used to perform the functions of components such as DU 240, CUs, and core 245. Functionality of such components can be co-located or located at disparate physical server systems.

Cellular network core 245 can be implemented on a public cloud-computing platform. A “public cloud-based computing platform” refers to a distributed computing platform where various unrelated entities can each establish an account and separately utilize the cloud computing resources, the cloud computing platform managing segregation and privacy of each entity's data.

Kubernetes, or some other container orchestration platform, can be used to create and destroy the logical DU, CU, or 5G core units and subunits, as needed, for the cellular network to function properly. Kubernetes allows for container deployment, scaling, and management. As an example, if cellular traffic increases substantially in a region, an additional logical DU or components of a DU may be deployed in a data center near where the traffic is occurring without any new hardware being deployed; rather, processing and storage capabilities of the data center would be devoted to the needed functions. When the need for the logical DU or subcomponents of the DU no longer exists (i.e., when traffic subsequently decreases), Kubernetes can allow for removal of the logical DU. Kubernetes can also be used to control the flow of data (e.g., messages) and inject a flow of data to various components. This arrangement can allow for the modification of nominal behavior of various layers.

The deployment, scaling, and management of such virtualized components can be managed by an orchestrator. An orchestrator can monitor the cellular network and determine the amount and location at which cellular network functions should be deployed to meet or attempt to meet service level agreements (SLAs) across slices of the cellular network.

A network slice functions as a virtual network operating on the cellular network. The Cellular network is shared with some number of other network slices, such as hundreds or thousands of network slices. Communication bandwidth and computing resources of the underlying physical network can be reserved for individual network slices, thus allowing the individual network slices to reliably meet particular service level agreement (SLA) levels and parameters. By controlling the location and amount of computing and communication resources allocated to a network slice, the SLA attributes for UE on the network slice can be varied on different slices. A network slice can be configured to provide sufficient resources for a particular application to be properly executed and delivered (e.g., gaming services, video services, voice services, location services, sensor reporting services, data services, etc.). However, such allocations also account for resource limitations, such as to avoid allocation of an excess of resources to any particular UE group and/or application. Further, a cost may be attached to cellular slices: the greater the amount of resources dedicated, the greater the cost to the user; thus, optimization between performance and cost is desirable. Accordingly, the use of slices can be extended to UEs 210 communicating with satellite 220. Via DU 240, each of UEs 210 can be provided with varying levels of service in accordance with their respective assigned slices.

Particular network slices may only be reserved in particular geographic regions. For instance, a first set of network slices may be present when the satellite is over a first geographic region and a second set of network slices, which may only partially overlap or may be wholly different from the first set, may be available when the satellite is over another geographic region.

Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

FIG. 4 illustrates an embodiment of a cellular network core network topology 400 as implemented on a public cloud-computing platform, according to certain embodiments. The cellular network core network topology 400 can be an implementation of cellular network core 245 of FIGS. 2 and 3. Cellular network core network topology 400 can represent how logical cellular network groups are distributed across cloud computing infrastructure of cloud computing platform 401. Cloud computing platform 401 can be logically and physically divided up into various different cloud computing regions 410. Each of cloud computing regions 410 can be isolated from other cloud computing regions to help provide fault tolerance, fail-over, load-balancing, and/or stability and each of cloud computing regions 410 can be composed of multiple availability zones, each of which can be a separate data center located in general proximity to each other (e.g., within 600 miles). Further, each of cloud computing regions 410 may provide superior service to a particular geographic region based on physical proximity. For example, cloud computing region 410-1 may have its datacenters and hardware located in the northeast of the United States while cloud computing region 410-2 may have its datacenters and hardware located in California. For simplicity, the details of the cellular network as executed in only cloud computing region 410-1 is illustrated. Similar components may be executed in other cloud computing regions of cloud computing regions 410 (410-2, 410-3, 410-n).

In other embodiments, cloud computing platform 401 may be a private cloud computing platform. A private cloud computing platform may be maintained by a single entity, such as the entity that operates the hybrid cellular network. Such a private cloud computing platform may be only used for the hybrid cellular network and/or for other uses by the entity that operates the hybrid cellular network (e.g., streaming content delivery).

Each of cloud computing regions 410 may include multiple availability zones 415. Each of availability zones 415 may be a discrete data center or group of data centers that allows for redundancy that allows for fail-over protection from other availability zones within the same cloud computing region. For example, if a particular data center of an availability zone experiences an outage, another data center of the availability zone or separate availability zone within the same cloud computing region can continue functioning and providing service. A logical cellular network component, such as a national data center, can be created in one or across multiple availability zones 415. For example, a database that is maintained as part of NDC 430 may be replicated across availability zones 415; therefore, if an availability zone of the cloud computing region is unavailable, a copy of the database remains up-to-date and available, thus allowing for continuous or near continuous functionality.

On a (e.g., public) cloud computing platform, cloud computing region 410-1 may include the ability to use a different type of data center or group of data centers, which can be referred to as local zones 420. For instance, a client, such as a provider of the hybrid cloud cellular network, can select from more options of the computing resources that can be reserved at an availability zone 415 compared to a local zone 420. However, a local zone 420 may provide computing resources nearby geographic locations where an availability zone 415 is not available. Therefore, to provide low latency, certain network components, such as regional data centers 440, can be implemented at local zones 420 rather than availability zones 415. In some circumstances, a geographic region can have both a local zone 420 and an availability zone 415.

In the topology of a 5G NR cellular network, 5G core functions of core 339 can logically reside as part of a national data center (NDC) 430. NDC 430 can be understood as having its functionality existing in cloud computing region 410-1 across multiple availability zones 415. At NDC 430, various network functions, such as NFs 432, are executed. For illustrative purposes, each NF 432, whether at NDC 430 or elsewhere located, can be comprised of multiple sub-components, referred to as pods (e.g., pod 411) that are each executed as a separate process by the cloud computing region 410. The illustrated number of pods 411 is merely an example; fewer or greater numbers of pods 411 may be part of the respective 5G core functions. It should be understood that in a real-world implementation, a cellular network core, whether for 5G or some other standard, can include many more network functions. By distributing NFs 432 across availability zones 415, load-balancing, redundancy, and fail-over can be achieved. In local zones 420, multiple regional data centers 440 can be logically present. Each of regional data centers 440 may execute 5G core functions for a different geographic region or group of RAN components. As an example, 5G core components that can be executed within an RDC, such as RDC 440-1, may be: UPFs 450, SMFs 460, and AMFs 470. While instances of UPFs 450 and SMFs 460 may be executed in local zones 420, SMFs 460 may be executed across multiple local zones 420 for redundancy, processing load-balancing, and fail-over.

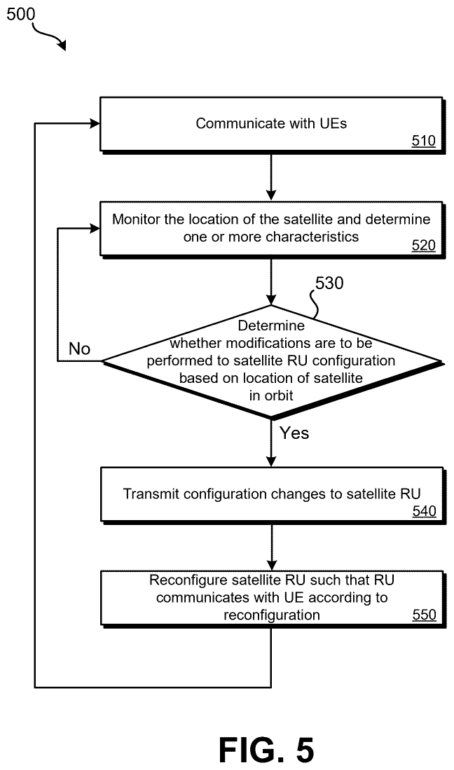

The systems of FIGS. 2-4 can be used to perform various methods. FIG. 5 illustrate an embodiment of a method 500 for using a non-terrestrial network system. Method 500 can be performed using system 200 and, possibly, the cellular network core embodiments detailed in relation to FIGS. 3 and 4.

At block 510, a satellite operating as part of a cellular network, such as a 5G NR cellular network, can provide cellular network access to multiple UEs. The UEs can be located in a same general geographic region, such as within geographic region 121, where a line-of-sight path is present between each UE and the satellite.

At block 520, the location of the satellite is monitored by the cellular network. Specifically, block 520 can be performed by a configuration manager, such as configuration manager 250 of FIG. 2. The satellite, when in LEO or MEO, travels along a highly predictable orbit. Therefore, at any given time, it can be determined with a high level of accuracy where the satellite will located and, thus, what geographic area will receive service from the satellite. The analysis of geographic area includes analyzing information that indicates historical demand over the geographic area. For example, demand over an area of ocean can be expected to be lower than over various areas of land. One or more other characteristics related to the satellite may optionally be monitored. For example, the time of day, day of week, and/or date may be monitored. Additionally or alternatively, information related to a TN of the cellular network in the geographic regions where the satellite will be or is providing service may be obtained. This information can be used to determine expected load. For example, when the satellite is overhead, load balancing may be performed between the satellite and the TN. Planned outages of the TN may also be treated as a characteristic. For example, if a BS is planned to be offline for a time period, the satellite may provide service to the UEs that would normally be serviced by the BS.

At block 530, a determination can be made by the configuration manager based on block 520 whether modifications to operational parameters are to be made to the radio unit on the satellite. The modifications to the RU can be based on any of the characteristics of block 520. In some embodiments, a machine learning model can be applied to determine the modifications, if any, that should be applied. If modifications are to be applied to the satellite-based RU, method 500 proceeds to block 540; otherwise, method 500 returns to block 520 to continue monitoring the location of the satellite and, possibly, other characteristics.

At block 540, the configuration changes are transmitted to the satellite RU using the O-RAN front end as modified parameters by the gateway. Such communication can involve communication via the M-Plane, C-Plane, S-Plane, and/or U-Plane. At block 550, the satellite RU is reconfigured based on the received parameters of block 540. In response, the RU modifies how it communicates with UE.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known, processes, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A non-terrestrial cellular network system, comprising:
a satellite, comprising a radio unit (RU), the satellite functioning as part of a cellular network; and
a gateway system, comprising a distributed unit (DU) and a configuration manager, wherein the configuration manager is configured to:
determine a characteristic of the non-terrestrial cellular network system;
analyze the characteristic of the non-terrestrial cellular network system;
transmit one or more updated parameters to the RU of the satellite in response to analyzing the characteristic, wherein:
the RU of the satellite is configured to update functionality based on the one or more updated parameters; and
the RU of the satellite is configured to communicate with a plurality of user equipment (UEs) in accordance with the updated one or more parameters.

2. The non-terrestrial cellular network system of claim 1, wherein the updated parameters include an adjustment to an advanced sleep mode (ASM) setting of the RU that causes one or more components of the RU to be powered down.

3. The non-terrestrial cellular network system of claim 2, the configuration manager is further configured to:
after transmitting the one or more updated parameters to the RU of the satellite in response to analyzing the characteristic, transmit an additional updated parameter to the RU comprising a wake-up command that adjusts the ASM setting and causes the one or more components of the RU at the satellite to be powered up.

4. The non-terrestrial cellular network system of claim 1, wherein the updated parameters include an adjustment to a beamforming pattern of the RU.

5. The non-terrestrial cellular network system of claim 1, wherein the updated parameters include an adjustment to a subcarrier spacing (SCS) at the RU.

6. The non-terrestrial cellular network system of claim 1, wherein the updated parameters include an adjustment to a channel bandwidth at the RU.

7. The non-terrestrial cellular network system of claim 1, wherein the characteristic of the non-terrestrial cellular network system comprises a location of the satellite in orbit.

8. The non-terrestrial cellular network system of claim 1, wherein the characteristic of the non-terrestrial cellular network system comprises an amount of UE traffic on the cellular network.

9. The non-terrestrial cellular network system of claim 1, wherein the characteristic of the non-terrestrial cellular network system comprises a beam-forming pattern of an antenna array of the satellite.

10. The non-terrestrial cellular network system of claim 1, wherein the RU of the satellite comprises a software-defined radio (SDR).

11. The non-terrestrial cellular network system of claim 1, wherein the one or more parameters comprises clock synchronization between the radio unit and the distributed unit.

12. The non-terrestrial cellular network system of claim 1, wherein the one or more parameters comprises a transmit buffer size, receive buffer size, or both at the radio unit.

13. A method for using a non-terrestrial cellular network system, the method comprising:
communicating, by a distributed unit located at a satellite gateway system, via a satellite, with a plurality of user equipment (UEs) via a cellular communication protocol;
determining, by a configuration manager of the satellite gateway system, a characteristic of the satellite;
analyzing, by the configuration manager of the satellite gateway system, the characteristic of the non-terrestrial cellular network system;
transmitting, by the satellite gateway system, one or more updated parameters to the RU of the satellite in response to analyzing the characteristic, wherein:
the RU of the satellite is configured to update functionality based on the one or more updated parameters; and
communicating, by the distributed unit located at the satellite gateway system, via the satellite and the RU using the one or more updated parameters, with the plurality of UEs via the cellular communication protocol.

14. The method for using the non-terrestrial cellular network system of claim 13, wherein the updated parameters include an adjustment to an advanced sleep mode (ASM) setting of the RU that causes one or more components of the RU to be powered down.

15. The method for using the non-terrestrial cellular network system of claim 14, further comprising:
after transmitting the one or more updated parameters to the RU of the satellite in response to analyzing the characteristic, transmitting, by the satellite gateway system, an additional updated parameter to the RU comprising a wake-up command that adjusts the ASM setting and causes the one or more components of the RU at the satellite to be powered up.

16. The method for using the non-terrestrial cellular network system of claim 13, wherein the updated parameters include an adjustment to a beamforming pattern of the RU.

17. The method for using the non-terrestrial cellular network system of claim 13, wherein the characteristic of the non-terrestrial cellular network system comprises a location of the satellite in orbit.

18. The method for using the non-terrestrial cellular network system of claim 13, wherein the characteristic of the non-terrestrial cellular network system comprises a beam-forming pattern of an antenna array of the satellite.

19. The method for using the non-terrestrial cellular network system of claim 13, wherein the one or more parameters comprises clock synchronization between the radio unit and the distributed unit.

20. The method for using the non-terrestrial cellular network system of claim 13, wherein the one or more parameters comprises a transmit buffer size, receive buffer size, or both at the radio unit.
